(19) United States
(12) Patent Application Publication
(10) Pub. No.: US 2026/0326176 A1
(43) Pub. Date: Oct. 22, 2026

(54) METHOD FOR THE TREATMENT OF ORGANIC WASTE

(71) Applicant: SUEZ INTERNATIONAL, Puteaux (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Puteaux (FR)

(21) Appl. No.: 19/112,307

(22) PCT Filed: Sep. 28, 2023
(86) PCT No.: PCT/EP2023/076994

§ 371 Date: Mar. 17, 2025

(30) Foreign Application Priority Data
Sep. 29, 2022 (FR) FR2209947

(51) Int. Cl. B09B 3/70; B01J 19/00; B09B 3/40

(52) U.S. Cl. CPC B09B 3/70; B01J 19/006; B09B 3/40; B01J 2219/3325

(57) ABSTRACT

A method for hydrotreating a mixture M1 comprising at least organic material. The method involves pressurizing the mixture M1 comprising at least organic material in order to obtain a stream of mixture M1p. The mixture M1p is then heated to obtain a stream of mixture M2. Stream M2 is introduced via an inlet E1 into a hydrotreatment reactor by injection facing an impact plate in order to create a mechanical impact. Water ES1 is vertically injected at a temperature of at least 374 °C directly into the hydrotreatment reactor via inlet E2. Then a stream M3 enriched with soluble materials is recovered, and a stream M4 depleted of soluble materials is recovered by an outlet S2 of the reactor. The outlet S2 and the inlet E2 are each located at an altitude lower than the inlet E1.

### TECHNICAL FIELD OF THE INVENTION

The invention relates to the field of biomass treatment, in particular sewage sludge, food and agri-food waste, manure digestate and agricultural residues.

### STATE OF THE ART

Hydrothermal treatments of biomass are becoming increasingly common. They require high temperatures. It is therefore essential to control the temperatures in order to achieve the desired hydrotreated biomass quality.

Controlling the temperatures and residence times of the method is thus extremely important to achieve the desired result. Temperatures that are too high or too low, or residence times that are too short or too long either prevent the desired reactions from taking place or lead to undesired secondary reactions resulting in an overall deterioration in desired performance, or worse, in the production of a residue with high processing costs.

In particular, the heating step of hydrothermal treatments is a major cause of these secondary reactions due to the long residence time at intermediate temperatures which can lead to the formation of unwanted compounds such as oils, tars or coal-like derivatives. The longer this heating step takes, the higher the temperatures to be reached, in particular when the temperatures to be reached are close to or higher than the supercritical water temperature.

Furthermore, in the state of the art, heating is often carried out via a “tube in tube” type exchanger to recover the output heat in order to reduce the amount of heat required for the process. However, in this type of exchanger, the low thermal conduction of the product to be heated results in a very wide variation in temperature inside the product and therefore different process conditions between the different parts of the product leading to unwanted parasitic reactions.

Finally, as biomass is not homogeneous, chemical reactions do not take place with identical kinetics throughout the biomass, particularly when said biomass contains massive particles, part of whose mass is not in direct contact with water.

There is therefore a need to provide a method for hydrotreating a biomass-type mixture, allowing improved heat exchange and less formation of unwanted compounds such as oils, tars or coal-like derivatives.

### SUMMARY OF THE INVENTION

The invention relates to a method for hydrotreating a mixture M1 comprising at least organic material, said method comprising:
a) pressurizing mixture M1 comprising at least organic material to a pressure ranging from 20 to 350 bar, in order to obtain a stream of mixture M1p,
b) a step of heating mixture M1p to a temperature ranging from 170 °C to 430 °C to obtain a stream of mixture M2,
c) introducing the stream M2 via an inlet E1 into a hydrotreatment reactor by injection facing an impact plate in order to create a mechanical impact,
d) a step of vertically injecting water ES1 at a temperature of at least 374 °C directly into the hydrotreatment reactor via inlet E2,
e) recovering a stream M3 enriched with soluble materials and a stream M4 depleted of soluble materials, the stream M4 being recovered by an outlet S2 of the reactor,
outlet S2 and inlet E2 each being located at an altitude lower than inlet E1.

Preferably, the recovery of stream M3 enriched with soluble materials in step e) is carried out through at least one filter, said filter comprising at least one filtration layer preferably having a mesh size of less than 100 μm, preferably less than 50 μm, still preferably less than 40 μm, said filter preferably being in the hydrotreatment reactor.

Preferably, step b) comprises at least one step of injecting water ES at a temperature of at least 374 °C into the stream of mixture M1p in order to obtain stream M2, the injected water preferably being at a pressure of at least 225 bar.

According to one embodiment, the recovery of stream M3 in step e) is controlled by determining the pressure difference between the pressure in the hydrotreatment reactor and the pressure in stream M3 at the outlet of the reactor downstream of the filter.

According to one embodiment, the hydrotreatment reactor is maintained at a temperature ranging from 150 °C to a temperature less than 374 °C.

Preferably, the method further comprises, downstream of the filter and downstream of the reactor, a step f) of injecting water at a temperature of at least 374 °C into stream M3, against said stream, where applicable said water preferably being at the same temperature and at the same pressure as the water injected in step b).

Preferably, when the injection of counter-current water in step f) is implemented, then outlet S2 of the reactor is opened to extract a stream M4.

According to one embodiment, the hydrotreatment reactor further comprises a baffle system for guiding the upward flow created by the vertical injection of water ES1 prior to extraction of stream M3 in step e) through an upper part of the reactor, preferably through a filter.

According to one embodiment, the method further comprises;
at least one heat exchange step X1 allowing heat to be recovered from stream M3 in order to at least partially heat the water to be injected in heating step b), a cooled stream M5′ then being obtained, and optionally comprising at least one additional water heating step, downstream of the heat exchange X1 allowing the water to be heated to the temperature of at least 374 °C prior to its injection in step d), and/or where applicable prior to its injection in step b) and/or where applicable prior to its injection in step f), and
optionally at least one heat exchange step X2 to recover heat from stream M5′ to heat mixture M1p upstream of the injection of water in step b), a stream M5″ then being obtained.

Preferably, the method further comprises:
at least one step of cooling at least one fraction of stream M5′ or where applicable stream M5″ to obtain steam and stream M6 comprising hydrotreated organic material, and
a step of injecting at least part of said steam to preheat mixture M1 upstream of pressurization step a), said mixture M1 preferably being preheated to a temperature ranging from 50 to 170 °C, preferentially from 50 to 90 °C,
optionally a step of cooling at least one fraction of stream M6 to obtain a cooled stream M6′ and optionally a step of digesting stream M6′.

According to one embodiment, the impact plate comprises an erosion-resistant thickening.

The invention also relates to an installation for implementing the hydrotreatment method according to the invention, said installation comprising:
a feed line for mixture M1,
a pressurization pump 2 supplied by the feed line for mixture M1 and comprising an outlet line for mixture M1p,
a heating device 11 supplied by at least one fraction of mixture M1p downstream of pump 2 and having an outlet for the stream of mixture M2,
downstream of the heating device, a hydrotreatment reactor 1 comprising an inlet E1 for injecting stream M2, an inlet E2 for injecting water ES1, an outlet S1 for extracting stream M3 and an outlet S2 for extracting stream M4, said reactor further comprising at least one impact plate located facing inlet E1 in order to create a mechanical impact when stream M2 is injected into the reactor,
a device for injecting water ES1 directly into the reactor allowing vertical injection from the bottom upwards via inlet E2 of the reactor 1, outlet S2 and inlet E2 each being located at an altitude lower than inlet E1.

Preferably, the hydrotreatment reactor 1 further comprises:
at least a first filter F1, said first filter being arranged so that the stream M3 enriched with soluble materials passes through the filter before exiting the reactor via outlet S1,
and optionally at least a second filter F1′, said second filter F1′ being arranged in such a way that stream M3′ enriched with soluble materials passes through said second filter F1′ before exiting reactor 1 via an outlet S1′, preferably, outlets S1 and S1′ are located in the upper part of hydrotreatment reactor 1 and preferably allow vertical extraction, from the bottom upwards of streams M3 and M3′ respectively.

Preferably, the hydrotreatment reactor 1 further comprises a baffle system to guide the upward flow created by the vertical injection of water via inlet E2 prior to its extraction via outlet S1, outlet S1 preferably being in the upper part of the reactor, allowing a vertical exit from the bottom upwards.

Preferably, the heating device 11 comprises at least one device for injecting water ES into the line of mixture M1p, said installation further preferably comprising:
a heat exchanger 6 downstream of the hydrotreatment reactor 1, said heat exchanger recovering heat from the line of stream M3, optionally combined with the line of stream M3′, to obtain stream M5′ and transferring this heat to the water upstream of the device for injecting water ES1 and/or upstream of the device for injecting water ES, and
optionally a water heating device 7, downstream of the heat exchanger 6 and upstream of the device for injecting water ES and upstream of the device for injecting water ES1, said heating device 7 advantageously comprising at least two outlet lines, one line connected to the device for injecting water ES1 and one line connected to the device for injecting water ES,

said installation preferably further comprising:
optionally a heat exchanger 8 for recovering heat from mixture M5′ to obtain mixture M5″ and for transferring this heat to mixture M1p upstream of the device for injecting water ES,
A cooling device 4 supplied by at least one fraction of stream M5′ or where applicable M5″ to produce steam and a cooled stream M6,
A device 3 for injecting said produced steam into the stream of mixture M1 upstream of the pressurization pump 2,
optionally a cooling device 9 downstream of the cooling device 4 supplied by at least one fraction of stream M6 for cooling at least one fraction of stream M6 to obtain stream M6′, and
optionally a digester 5 supplied by stream M6′.

The invention first and foremost makes it possible to separate the residence times between the massive particles making up the biomass, for which the chemical reaction times (in particular solubilization) must be longer, and the solubilized molecules, which must be evacuated from the reactor more quickly to avoid secondary reactions for example repolymerization.

The invention also allows the biomass to be brought up to temperature very quickly by direct heating which in turn allows the desired process conditions to be controlled.

The invention allows the method to maintain thermal recovery by heating the water under supercritical conditions in order to minimize the overall thermal consumption of the method.

Biomass has a certain viscosity. However, viscosity makes heat exchange difficult. The viscosity of water is lower than that of any biomass, therefore heating water will result in a smaller recovery exchanger and therefore lower cost.

The invention proposes injecting supercritical water directly into the stream of organic material M1. Thus, the thermal shock between the organic material (M1) part of which is cellular content and the very hot supercritical water will cause local cavitations due to the difference in local density and therefore local pressure. These cavitations allow an immediate release of the cell contents into the aqueous matrix and therefore subsequently the immediate reaction of the proteins and sugars contained in the bacteria in the hydrotreatment reactor.

The invention further makes it possible to initiate maximum particle size separation by means of an impact plate at the inlet of the reactor by allowing an element made up of larger particles to be pulverized, i.e. converted into smaller particles.

### BRIEF DESCRIPTION OF THE FIGURES

FIG. 1 depicts an installation according to one embodiment of the method according to the invention.

FIG. 2 depicts an installation according to one embodiment of the method according to the invention.

FIG. 3 depicts an installation according to one embodiment of the method according to the invention.

FIG. 4 depicts an installation according to one embodiment of the method according to the invention.

FIG. 5 depicts an installation according to one embodiment of the method according to the invention.

FIG. 6 depicts an installation according to one embodiment of the method according to the invention.

### DETAILED DESCRIPTION OF THE INVENTION

The invention relates to the hydrothermal treatment of mixture M1 comprising organic material.

Mixture M1 is typically a biomass. Biomass can be a paste or liquid; it may particularly be sewage sludge, food and agri-food waste, especially manure digestate and agricultural residues.

The invention relates to a method for hydrotreating a mixture M1 comprising at least organic material, said method comprising:
a) pressurizing mixture M1 comprising at least organic material to a pressure ranging from 20 to 350 bar in order to obtain a stream of mixture M1p preferably having a pressure of least 40 bar,
b) a step of heating mixture M1p to a temperature ranging from 170 °C to 430 °C, preferably from 250 °C to 350 °C to obtain a stream of mixture M2,
c) introducing stream M2 into a hydrotreatment reactor by injection facing an impact plate in order to create a mechanical impact,
d) a step of vertically injecting water ES1 at a temperature of at least 374 °C directly into the hydrotreatment reactor in the lower part of said reactor,
e) recovering a stream M3 enriched with soluble materials and a stream M4 depleted of soluble materials, the recovery of stream M4 being carried out in the lower part of said reactor.

For the purposes of the present invention, the expression “at least one fraction of a mixture or stream” has the same meaning as the expression “all or part of said mixture or stream”. In the case of a part of said mixture or of said stream, this expression refers to a certain proportion of said mixture or said stream. For example, for the purposes of this expression, “each fraction of the mixture” or “each fraction of the stream” will have the same composition.

For the purposes of the present invention, the expression “where applicable of step X” introduces a feature that is present when step X is present.

For the purposes of the present invention, the expression “where applicable of stream X” introduces a feature that is present when stream X is present.

### Pressurization Step a)

The method according to the invention comprises a step of pressurizing mixture M1 preferably to a pressure ranging from 20 to 350 bar, preferably from 50 to 300 bar, preferably ranging from 150 to 270 bar, preferably from 170 to 220 bar, said mixture M1 can be optionally already pressurized before step a).

In particular, pressurization allows mixture M1 to be brought to a pressure sufficient for the mixture to be in a predominantly liquid phase. More specifically, the pressure in mixture M3 will typically be higher than the saturated vapor pressure of said mixture M3 to maintain the water in liquid phase.

For the pressurization step, a pump may be provided on the line of mixture M1.

Downstream of the pressurization, a stream of mixture M1p is obtained.

### Heating Step b)

The method of the invention comprises a step of heating mixture M1p to a temperature ranging from 170 to 430 °C, preferably from 250 °C to 350 °C to obtain a stream of mixture M2.

This heating can be carried out in one or more steps. A sub-step can be heating by an external heat flow (electric heater, hot fluid heat exchanger (gas/liquid), microwave, etc.) or water injection.

Thus, according to a preferred embodiment, the heating step b) comprises at least a step during which water ES at a temperature of at least 374 °C is injected into the stream of mixture M1p in order to obtain a stream of mixture M2 comprising water and organic material. Mixture M2 will typically also comprise inorganic material.

The water may for example be injected at an angle ranging from 15° to 90°, preferably from 45°to 90°, or even from 45° to 75°, with respect to the feed line for stream M1p.

According to one embodiment, mixture M1p during the injection of water in step b) is at a temperature ranging from 90 °C to 300 °C. In this case, heating step b) may optionally comprise a sub-step of heating by an external heat flow (electrical heating, hot fluid heat exchanger (gas/liquid), microwaves, etc.).

Upstream of the injection of water carried out in step b), the injected water will typically be at a higher pressure than the pressure of mixture M1p.

According to a preferred embodiment of the invention, the water injected in step b) is at a pressure of at least 225 bar. According to this embodiment, the injected water will then be referred to as “supercritical water”.

According to one embodiment, the heating step b) of the method comprises two sub-steps:
a first heat exchange sub-step between stream M1p and stream M3, said stream M3 having optionally been subjected to one or more heat exchanges between the outlet of the reactor and this heat exchange with M1p,
a second sub-step of injecting water ES at a temperature of at least 374 °C and preferably at a pressure of at least 225 bar, into the line of stream M1p downstream of the first sub-step.

According to one embodiment, the method of the invention comprises at least one water heating step to obtain water at the temperature of at least 374 °C upstream to the injection thereof in step b).

According to one embodiment, the method according to the invention comprises a step of pressurizing the water to a pressure of at least 225 bar followed by at least one step of heating the water to obtain water at the temperature of at least 374 °C upstream of the injection thereof in step b).

Preferably, at least one water heating step is implemented by heat exchange with the heat of at least one fraction of stream M3 enriched with soluble materials exiting the hydrotreatment reactor, the stream thus cooled being referred to as stream M3′ at the end of this heat exchange (this could be the heat exchange step X1 described below).

At the injection outlet between the water and the sludge M1p, a static turbulator (for example, selected from propellers, blades, pipe bends, or combinations thereof) can also be introduced to increase turbulence and rapid heat exchange between the sludge and the water and prevent the sludge and the water from remaining in separate flows (in order to avoid laminar hydraulic lines).

Thus, according to one embodiment of the invention, upstream of step c), mixture M2 is introduced into a static turbulator, said static turbulator then being located upstream or at the inlet of the hydrotreatment reactor.

According to one embodiment, a static turbulator is present upstream or at the inlet of the hydrotreatment reactor in order to increase turbulence in mixture M2.

According to a particular embodiment, the line of stream M2, downstream of the water injection when present, comprises one or more pipe bends upstream of the hydrotreatment reactor.

### Step of Introducing Stream M2 c)

The method according to the invention comprises a step of introducing stream M2 into a hydrotreatment reactor. The hydrotreatment reactor typically comprises an inlet E1 for introducing stream M2, and the reactor comprises at least one impact plate facing said inlet E1. This impact plate thus creates a mechanical impact within stream M2 when stream M2 is introduced via inlet E1.

According to one embodiment, the impact plate is a siphonic partition, that is to say that the stream can then pass over and under the plate.

The mechanical impact resulting from the introduction of stream M2 will modify the direction of flow of stream M2 and thus the velocity of the particles suspended undissolved in this fluid according to their densities. This will allow the separation of the undissolved particles (solids), thus leading to a settling phenomenon towards the bottom of the reactor of the non-hydrotreated solid material (stream depleted of soluble materials), while the low-density hydrotreated material (stream enriched with soluble materials) will flow towards the top of the reactor.

The hydrotreatment reactor is advantageously maintained at a temperature ranging from 150 °C to 430 °C. For example, the temperature can be maintained by peripheral heat exchange with a hot fluid, by placing the equipment inside a temperature-maintained furnace, or by using an electric heating collar.

According to one embodiment, the impact plate comprises a thickening to protect it over time from erosion caused by impact.

According to one embodiment, the inlet diameter in the reactor allows a feed speed greater than 3 m/s, preferentially greater than 6 m/s, preferentially greater than 10 m/s.

Within the context of the method of the invention, the flow rates of the streams of injected water, preferably supercritical water, and mixture M1p are advantageously controlled and will typically allow the new mixture (so-called mixture M2) to have a residence time in the hydrotreatment reactor ranging from 1 minute to 30 minutes, preferably 10 minutes to 15 minutes.

### Vertical Water Injection Step d)

The method according to the invention comprises a step d) of vertically (with respect to gravity) injecting water at a temperature of at least 374 °C directly into the hydrotreatment reactor, from the bottom upwards. Preferably, the water injected in step d) is at a pressure of at least 225 bar. According to this embodiment, the injected water will then be referred to as “supercritical water”.

This water injection step thus helps to maintain the temperature of the hydrotreatment reactor.

Preferably, the hydrotreatment reactor further comprises therewithin (in its volume) a baffle system to guide the upflow created by the vertical injection of water in step d), prior to recovering the stream(s) enriched with soluble materials downstream of the reactor in step e).

This baffle system can consist of plates that guide the upward flow towards the top of the reactor and then towards the bottom of the reactor, the latter guidance preferably stopping at an altitude lower than that of the filter. The soluble material at the end of this baffle system can then be drawn through the filter present in the reactor while the solid (non-soluble) material returns to the bottom of the reactor.

Said plates can be of different lengths and are at different altitudes to allow the desired guidance inside the reactor.

This water injection system in the lower part of the reactor extends the residence time of non-soluble or poorly soluble materials (solids), so that they are not immediately removed from the reactor.

When the water injection system is coupled with a baffle system, the residence time is further extended to improve solubilization in the hydrotreatment reactor. This baffle system further prevents poorly soluble or non-soluble material from sticking to and clogging the filter.

According to one embodiment, the method of the invention comprises at least one water heating step to obtain water at the temperature of at least 374 °C upstream to the injection thereof in step d).

According to one embodiment, the method according to the invention comprises a step of pressurizing the water to a pressure of at least 225 bar followed by at least one step of heating the water to obtain water at the temperature of at least 374 °C upstream of the injection thereof in step d).

Preferably, at least one water heating step is implemented by heat exchange with the heat of at least one fraction of stream M3 enriched with soluble materials exiting the hydrotreatment reactor, the stream thus cooled being referred to as stream M3′ at the end of this heat exchange (this could be the heat exchange step X1 described below).

### Step of Recovering Stream M3 and Stream M4 e)

Downstream of the hydrotreatment reactor, a stream M3 enriched with soluble materials and a stream M4 depleted of soluble materials are recovered.

The stream depleted of soluble materials M4 is extracted from the reactor in the lower part of said reactor.

Stream M3 can be recovered downstream of one or more filters, said filter(s) can be present in the reactor and/or downstream of the reactor on the line of stream M3.

According to an advantageous embodiment of the invention, the recovery of stream M3 enriched with soluble materials in step e) is carried out through at least one filter, preferably said at least one filter is present in the hydrotreatment reactor.

When the filter is present in the hydrotreatment reactor, the filter surface area is increased and filters with a larger specific surface area can be used, particularly when compared with a filter present in the piping.

Additionally, when the filter is outside the hydrotreatment reactor, it may be either in the piping or in another reactor downstream of the hydrotreatment reactor, but in either case, the filter will clog more quickly than when the filter is in the hydrotreatment reactor.

The filter limits the size of solid particles in the stream of hydrotreated organic material M3, also known as the stream enriched with soluble materials.

The filter may comprise one or more filtration layers, which may optionally have different mesh sizes. Preferably, the outer filtration layers have larger mesh sizes than the inner filtration layers.

According to one embodiment, the filter has a mesh size of less than 100 μm, preferably less than 50 μm, even more preferably less than 40 μm. When the filter comprises several filtration layers, the finest mesh size will preferably be less than 100 μm, preferably less than 50 μm, even more preferably less than 40 μm.

According to a particular embodiment, a second filter is present in the hydrotreatment reactor or downstream of the hydrotreatment reactor on an outlet line of stream M3′ separate from the line of stream M3. Thus, the second filter is configured such that the material enriched with soluble materials is extracted from the reactor via this second filter. This second stream extracted via the second filter is referred to as M3′. The second filter will extract hydrotreated material (enriched with soluble materials) when the first filter is saturated and while the first filter is being cleaned. Once the first filter has been cleaned, it will resume its filtration role. This second outlet of material enriched with soluble materials is thus advantageously open during the backflush period implemented on the first filter.

Advantageously according to this embodiment, the second filter will have a different mesh size to that of the first filter (filter for extracting stream M3), preferably a larger mesh size to that of the first filter.

Thus, according to this embodiment, the second filter will preferably have a mesh size of less than 200 μm, preferably less than 100 μm.

According to a particular embodiment, the first filter has a mesh size of less than 40 μm and the second filter has a mesh size of less than 100 μm.

This second filter may also comprise one or more filtration layers which may optionally have different mesh sizes, preferably the outer filtration layers have larger mesh sizes than the inner filtration layers. When the second filter comprises several filtration layers, then preferably, the finest mesh size is preferably less than 200 μm, preferably less than 100 μm.

According to one embodiment, the recovery of stream M3 in step e) is controlled by determining the pressure difference between the pressure in the hydrotreatment reactor and the pressure in stream M3 at the outlet of the reactor downstream of the filter. According to one embodiment, stream M3 is recovered, typically by opening a valve V1 on the line of stream M3 downstream of the filter, as long as the pressure difference is less than a predetermined threshold value, for example when the pressure difference is less than 10 bar.

This pressure difference check ensures that the filter is not excessively clogged.

According to one embodiment, stream M3 is extracted at the upper part of the hydrotreatment reactor, via a vertical outlet line (with respect to gravity). Thus, according to this embodiment, the stream enriched with soluble materials M3 is preferably extracted from the reactor by a stream circulating from the bottom upwards (with respect to gravity).

Preferably, the hydrotreatment reactor thus comprises at least one outlet in the upper part, at least a second outlet in the lower part, and optionally at least a third outlet located in the upper part.

For the purposes of the present invention, the term “lower part” is used in contrast to “upper part”. Thus, an outlet in the upper part will be at a higher altitude than the outlet in the lower part. Similarly, an outlet in the upper part will be at a higher altitude than an inlet in the lower part.

The method of the invention thus comprises introducing a stream M2, extracting a stream M3 and extracting a stream M4. Preferably, the entry of mixture M2 is via an inlet E1 of the hydrotreatment reactor, the exit of stream M3 is via an outlet S1 and the exit of stream M4 is via an outlet S2.

Thus, according to an advantageous embodiment, inlet E1 is located at an altitude lower than outlet S1 and inlet E1 is located at an altitude higher than outlet S2 to extract stream M4.

When a second filter is present, stream M3′ is extracted from the reactor via a third outlet S1′, separate from outlets S1 and S2. Thus, preferably, according to this embodiment, outlet S1′ is located at an altitude higher than inlet E1, inlet E1 itself being at an altitude higher than outlet S2. Preferentially, outlets S1 and S1′ are at similar or even identical altitudes.

All of these configurations (E1, S1, S2 and where applicable S1′) thus optimizes residence times and promotes solubilization of the material in the reactor.

### Other Steps

According to one embodiment, the method further comprises a step f) during which water ES2 at a temperature of at least 374 °C is injected into the line of stream M3 exiting the hydrotreatment reactor downstream of the filter, preferably said water is at a pressure of at least 225 bar, more preferably said water ES2 injected into the line of stream M3 is at the same temperature and at the same pressure as the water ES1 injected into the reactor in step d) and/or said water ES2 injected into the line of stream M3 is where applicable (i.e. when step b) comprises an injection of water ES) at the same temperature and at the same pressure as the water injected into stream M1p in step b).

Thus, this injection of water ES2, preferably supercritical water, is carried out against stream M3 exiting the hydrotreatment reactor. According to one embodiment, this counter-current water injected into the line of stream M3 is obtained by the same method as that described for the water injected in step b) and/or where applicable in step b) (advantageously heat exchange X1 then additional heating).

Typically, during this injection of counter-current water into stream M3, stream M3 is no longer extracted from the hydrotreatment reactor, typically by closing a valve V1 present downstream of the hydrotreatment reactor and downstream of the filter on the outlet line of stream M3. The injection of water ES2 then typically takes place between the filter and valve V1.

This injection of water into stream M3 allows the first filter to be backflushed. This washing step can be carried out at the same time as the recovery of stream M4 from the bottom outlet of the reactor, for example by opening a valve V2 on the line of stream M4. Thus, this injection of counter-current water can be triggered when the pressure difference between the pressure in the hydrotreatment reactor and the pressure in stream M3 at the outlet of the reactor exceeds a certain predetermined threshold, for example from 10 bar.

According to one embodiment of the method of the invention, when an injection of counter-current water ES2, preferably supercritical water, is implemented in stream M3, then preferably the outlet of the reactor in the lower part is opened (during said water injection), via the opening of a valve V2 downstream of the hydrotreatment reactor on the line of stream M4, in order to extract a stream M4 depleted of soluble materials.

For the purposes of the present invention, “stream enriched with soluble materials” means a stream comprising a mass proportion of soluble materials greater than the mass proportion of soluble materials in mixture M2.

For the purposes of the present invention, “stream depleted of soluble materials” means a stream comprising a mass proportion of soluble materials less than the mass proportion of soluble materials in mixture M2.

For the purposes of this invention, a soluble material will be a material obtained after filtration through a 40 μm filter (material not retained by said 40 μm filter) and subsequent drying of an initial material.

Thus, according to one embodiment, the ratio between the concentration of soluble materials in stream M3 and the concentration of soluble materials in stream M4 is at least 2, preferably at least 4, even more preferably at least 6, or even at least 10.

According to one embodiment using a second filter, during backwashing of the first filter, the outlet of stream M3 is closed (by virtue for example of a valve V1) and it is possible for a stream M3′ enriched with soluble materials to be extracted from the reactor via the second filter during said backwashing of the first filter.

Preferably, each of the outlets of stream M3 and M3′ is located in the upper part of the reactor, so that the stream can exit vertically, from the bottom upwards.

Thus, according to this embodiment, a first valve V1 is present on the outlet of stream M3 and a second valve V1′ is present on the outlet of stream M3′. Preferably according to this embodiment, when the first valve V1 is open, then either the second valve V1′ is open or the second valve V2 is open or both valves V1′ and V2 are open.

According to the embodiment using two filters, said filters can be (i) in the hydrotreatment reactor or (ii) downstream of the hydrotreatment reactor or (iii) one of the two filters can be in the reactor and the other filter can be downstream of the reactor. According to this embodiment, two streams enriched with soluble materials M3 and M3′ are then obtained downstream of the hydrotreatment reactor and downstream of said filters. Advantageously, the two lines of stream M3 and M3′ are combined, typically downstream of valves V1 and V1′.

According to a particularly advantageous embodiment, the method of the invention further comprises at least one heat exchange step X1 to recover heat from stream M3, optionally combined with stream M3′ to at least partially heat water W1 to be injected in step d) and to be injected where applicable in heating step b). Downstream of heat exchange X1, the cooled stream M3 (optionally combined with stream M3′) is referred to as stream M5′ and the heated water W1 is referred to as water W2.

Typically, according to this embodiment, the method of the invention further comprises at least one step of heating water W2, downstream of said heat exchange X1, allowing the water to be heated to the temperature of at least 374 °C prior to the injection thereof in step d), and where applicable in step b).

When the method of the invention comprises a heat exchange step X1, said heat exchange step X1 is preferably carried out with water having a pressure of at least 225 bar, thus it will preferably be carried out after a step of pressurizing water W1 to a pressure of at least 225 bar.

Preferentially, according to the embodiment implementing two filters, heat exchange X1 is implemented downstream of the recombination of lines of stream M3 and M3′.

According to one embodiment, the method of the invention further comprises a heat exchange step X2 for recovering heat from stream M5′ to heat mixture M1p (preferably upstream of the injection of water ES) in step b) of the method. This heat exchange then results in a cooled stream M5″.

Stream M1p downstream of heat exchange X2 may typically have a temperature ranging from 90 to 170 °C.

Said heat exchange step X2 can be combined with another external heating step to heat mixture M1p to the desired temperature during the implementation of step b), it may in particular involve heating by injecting water at a temperature of at least 374 °C.

Stream M5″ may typically have a temperature ranging from 100 to 200 °C.

Preferably, according to this embodiment, the hydrotreatment method according to the invention further comprises:
a step of cooling at least one fraction of stream M5″ to obtain steam and stream M6 enriched with soluble materials, and
a step of injecting at least part of said steam to preheat mixture M1 upstream of pressurization step a).

The cooling step can be carried out using a cooling device selected from a heat exchanger which may or may not be integrated in a Rankine, flash or scrubber cycle, preferably using a flash.

The steam produced during cooling is, according to this embodiment, used to preheat mixture M1 upstream of pressurization step a).

Preferably, according to this embodiment, mixture M1 is preheated upstream of pressurization step a) to a temperature ranging from 50 to 170 °C, preferentially from 50 to 90 °C, by virtue of steam from cooling at least one fraction of stream M5″. It should be noted that mixture M1 may optionally already be pressurized, prior to step a) as defined in the invention.

The invention thus allows better optimization of the viscosity of biomass undergoing high-pressure treatment. Indeed, the difficulty of pumping at these high pressures requires a minimum viscosity of the biomass to be pumped in order to meet the specifications of very high-pressure pumps.

By injecting steam into mixture M1, all of the possibilities are used to reduce the viscosity of the biomass to a value acceptable to pumping technologies, while minimizing biomass dilution which can cause additional costs in downstream equipment sizing (residence times to be respected, etc.).

According to one embodiment, the cooling of at least one fraction of stream M5′ or where applicable M5″ is carried out at a regulated pressure based on the preheating temperature of mixture M1 upstream of pressurization step a).

Indeed, the pressure and the temperature are linked for saturated steam. Maintaining a constant pressure makes it possible to control the temperature of the steam and therefore the maximum temperature that can be reached by the product heated by the steam (mixture M1 in the case of the invention).

For example, the pressure can be maintained between 2 and 10 bar.

According to one embodiment, the method according to the invention further comprises an additional step of cooling at least one fraction of stream M6 (enriched with soluble materials) to obtain stream M6′ followed by a step of introducing said stream M6′ into a digester to allow digestion of the organic material contained in stream M6′.

The additional cooling step for example cools stream M6 to a temperature less than or equal to 100 °C, preferably less than or equal to 60 °C, more preferably less than or equal to 40 °C.

According to one embodiment, cooled stream M6′ is then introduced into a digester to undergo a digestion step.

The digestion can be implemented according to any digestion method known to the person skilled in the art.

According to one embodiment, the treatment method according to the invention comprises at least one anaerobic digestion step carried out on stream M6′.

Anaerobic digestion may be mesophilic or thermophilic.

When mesophilic digestion is used, the temperature in the digester ranges from 33 °C to 37 °C and the residence time is 16 to 22 days.

When thermophilic digestion is used, the temperature in the digester ranges from 55 °C to 60 °C and the residence time is 10 to 12 days.

Residence time and temperature are two factors influencing the proper degradation of sludge and therefore the optimization of energy production.

When the stream to be digested is sufficiently liquid, digestion can be of the UASB type and residence times reduced.

At the end of the digestion step, a biogas is obtained.

This biogas typically comprises a mixture substantially consisting of methane, carbon dioxide and water. The biogas may optionally comprise other gases, such as hydrogen, oxygen, nitrogen, hydrogen sulfide, but these other gases collectively represent less than 10% by weight of the biogas, of the total weight of the biogas.

According to one embodiment, at least one fraction of stream M3 enriched with soluble materials exiting the reactor is sent to one or more post-treatment steps.

In the embodiment implementing two filters, the two lines of stream M3 and M3′ are advantageously recombined upstream of the post-treatment steps.

Among the post-treatments that can be implemented are a supplementary heating step and a hydrothermal gasification step. According to this embodiment, the heat exchange(s) (X1, X2) described in the present invention and the digestion described in the invention will be carried out where applicable, downstream of said post-treatments.

According to a particular embodiment of the invention, the hydrotreatment method comprises:
a. pressurizing mixture M1 comprising at least organic material in order to obtain a stream of mixture M1p having a pressure ranging from 150 to 350 bar,
b. a step of heating mixture M1p to a temperature ranging from 250 °C to 350 °C to obtain a stream of mixture M2,
c. introducing the stream M2 via an inlet E1 into a hydrotreatment reactor by injection facing an impact plate in order to create a mechanical impact, said impact plate preferably being a siphonic partition,
d. a step of vertically injecting water ES1 at a temperature of at least 374 °C and a pressure of at least 225 bar directly into the hydrotreatment reactor via inlet E2,
e. recovering a stream M3 enriched with soluble materials and a stream M4 depleted of soluble materials, the stream M4 being recovered by an outlet S2 of the reactor,
the outlet S2 and the inlet E2 each being located at an altitude lower than the inlet E1,
outlet S2 being at an altitude higher than inlet E2.

According to a particular embodiment of the invention, the hydrotreatment method comprises:
a. pressurizing mixture M1 comprising at least organic material in order to obtain a stream of mixture M1p having a pressure ranging from 150 to 350 bar,
b. a step of heating mixture M1p to a temperature ranging from 250 °C to 350 °C to obtain a stream of mixture M2,
c. introducing the stream M2 via an inlet E1 into a hydrotreatment reactor by injection facing an impact plate in order to create a mechanical impact, said impact plate preferably being a siphonic partition,
d. a step of vertically injecting water ES1 at a temperature of at least 374 °C and a pressure of at least 225 bar directly into the hydrotreatment reactor via inlet E2,
e. recovering a stream M3 enriched with soluble materials and a stream M4 depleted of soluble materials, the stream M4 being recovered by an outlet S2 of the reactor,
the outlet S2 and the inlet E2 each being located at an altitude lower than the inlet E1,
outlet S2 being at an altitude higher than inlet E2,
stream M3 being recovered downstream of a filter preferably present in the hydrotreatment reactor, said filter having at least one filtration layer having a mesh size of less than 40 μm.

According to a particular embodiment of the invention, the hydrotreatment method comprises:
a. pressurizing mixture M1 comprising at least organic material in order to obtain a stream of mixture M1p having a pressure ranging from 150 to 350 bar,
b. a step of heating mixture M1p to a temperature ranging from 250 to 350 °C, to obtain a stream of mixture M2, said heating step comprising at least one step of injecting water ES at a temperature of at least 374 °C and at a pressure of at least 225 bar,
c. introducing the stream M2 via an inlet E1 into a hydrotreatment reactor by injection facing an impact plate in order to create a mechanical impact, said impact plate preferably being a siphonic partition,
d. a step of vertically injecting water ES1 at a temperature of at least 374 °C and a pressure of at least 225 bar directly into the hydrotreatment reactor via inlet E2,
e. recovering a stream M3 enriched with soluble materials and a stream M4 depleted of soluble materials, the stream M4 being recovered by an outlet S2 of the reactor,
the outlet S2 and the inlet E2 each being located at an altitude lower than the inlet E1,
outlet S2 being at an altitude higher than inlet E2,
stream M3 being recovered downstream of a filter preferably present in the hydrotreatment reactor, said filter having at least one filtration layer having a mesh size of less than 40 μm,
the stream of mixture M2 supplying a static turbulator present upstream of the hydrotreatment reactor.

According to a particular embodiment of the invention, the hydrotreatment method comprises:
a. pressurizing mixture M1 comprising at least organic material in order to obtain a stream of mixture M1p having a pressure ranging from 150 to 350 bar,
b. a step of heating mixture M1p to a temperature ranging from 250 to 350 °C, to obtain a stream of mixture M2, said heating step comprising at least one step of injecting water ES at a temperature of at least 374 °C and at a pressure of at least 225 bar,
c. introducing the stream M2 via an inlet E1 into a hydrotreatment reactor by injection facing an impact plate in order to create a mechanical impact, said impact plate preferably being a siphonic partition,
d. a step of vertically injecting water ES1 at a temperature of at least 374 °C and a pressure of at least 225 bar directly into the hydrotreatment reactor via inlet E2,
e. recovering a stream M3 enriched with soluble materials and a stream M4 depleted of soluble materials, the stream M4 being recovered by an outlet S2 of the reactor,
the outlet S2 and the inlet E2 each being located at an altitude lower than the inlet E1,
outlet S2 being at an altitude higher than inlet E2,
stream M3 being recovered downstream of a filter preferably present in the hydrotreatment reactor, said filter having at least one filtration layer having a mesh size of less than 40 μm,
the hydrotreatment reactor further comprising a baffle system to guide the upward flow created by the vertical injection of water in step d), prior to recovering stream M3 enriched with soluble materials downstream of the reactor.

According to a Particular Embodiment of the Invention, the hydrotreatment method comprises:
a. pressurizing mixture M1 comprising at least organic material in order to obtain a stream of mixture M1p having a pressure ranging from 150 to 350 bar,
b. a step of heating mixture M1p to a temperature ranging from 250 to 350 °C, to obtain a stream of mixture M2, said heating step comprising at least one step of injecting water ES at a temperature of at least 374 °C and at a pressure of at least 225 bar,
c. introducing the stream M2 via an inlet E1 into a hydrotreatment reactor by injection facing an impact plate in order to create a mechanical impact, said impact plate preferably being a siphonic partition,
d. a step of vertically injecting water ES1 at a temperature of at least 374 °C and a pressure of at least 225 bar directly into the hydrotreatment reactor via inlet E2,
e. recovering a stream M3 enriched with soluble materials and a stream M4 depleted of soluble materials, the stream M4 being recovered by an outlet S2 of the reactor,
the outlet S2 and the inlet E2 each being located at an altitude lower than the inlet E1,
outlet S2 being at an altitude higher than inlet E2,
stream M3 being recovered downstream of a filter preferably present in the hydrotreatment reactor, said filter having at least one filtration layer having a mesh size of less than 40 μm,
the hydrotreatment reactor further comprising a baffle system to guide the upward flow created by the vertical injection of water in step d), prior to recovering stream M3 enriched with soluble materials downstream of the reactor,

said method further comprising:
a step of pressurizing water W1 to a pressure of at least 225 bar,
a heat exchange step X1 downstream of said water pressurization, allowing heat to be recovered from stream M3 to at least partially heat water W1 to be injected in step d) and/or step b) and/or step f), allowing a cooled stream M5′ and a stream of heated water W2 to be obtained downstream of exchange X1,
an additional heating step carried out on the stream of heated water W2, downstream of said heat exchange X1, allowing the water to be heated to the temperature of at least 374 °C prior to the injection thereof in step d) and/or in step b),
a heat exchange step X2, downstream of the heat exchange X1, allowing heat to be recovered from stream M5′ to heat mixture M1p upstream of the injection of water in step b) of the method, this heat exchange X2 then making it possible to obtain a cooled stream M5″.

The invention also relates to an installation for implementing the hydrotreatment method according to the invention.

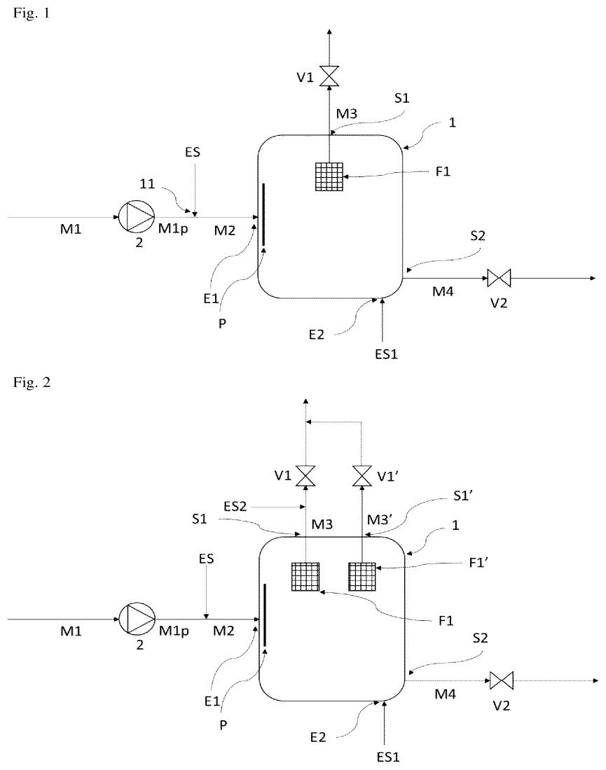

FIG. 1 to FIG. 6 exemplify embodiments of the invention, without limiting the scope thereof.

The installation according to the invention comprises:
a feed line for mixture M1,
a pressurization pump 2 supplied by the feed line for mixture M1 and comprising an outlet line for mixture M1p,
a heating device 11 supplied by at least one fraction of mixture M1p downstream of pump 2 and having an outlet for the stream of mixture M2,
downstream of the heating device, a hydrotreatment reactor 1 comprising an inlet E1 for injecting stream M2, an inlet E2 for injecting water, an outlet S1 for extracting stream M3 and an outlet S2 for extracting stream M4, said reactor further comprising at least one impact plate P located facing inlet E1 in order to create a mechanical impact when injecting stream M2 into the reactor,
a device for injecting water ES1 directly into the reactor allowing vertical injection from the bottom upwards via inlet E2 of the reactor 1,
outlet S2 and inlet E2 each being located at an altitude lower than inlet E1.

According to a preferred embodiment, inlet E2 is at an altitude lower than outlet S2.

According to one embodiment of the installation, the heating device 11 is selected from one or more components of: a water injection device, an external heating device, said external heating device can be selected from an electrical heating device, a hot fluid (gas/liquid) heat exchanger, a microwave heating device, or a combination thereof.

According to a preferred embodiment of the invention, the heating device 11 comprises at least one device for injecting water ES into the line of mixture M1p. This embodiment is exemplified in the figures.

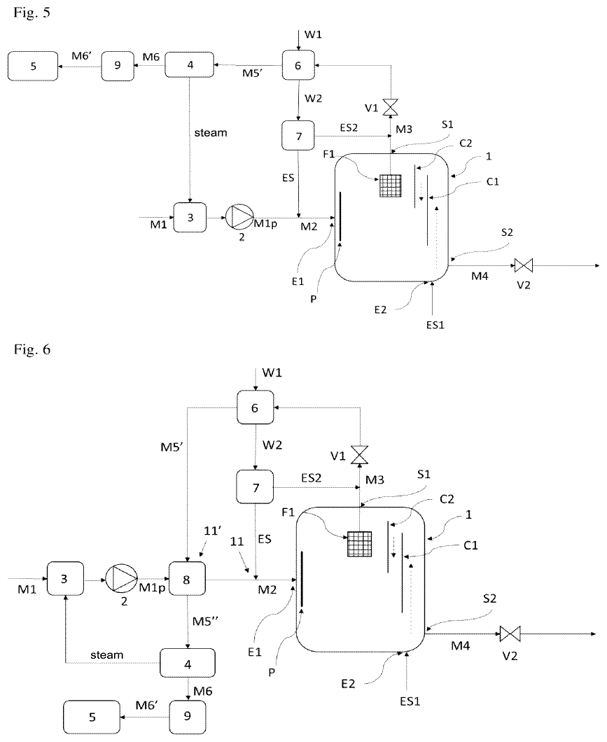

According to one embodiment, the heating device 11,11′ comprises a heat exchanger 8 and a device for injecting water ES into the line of mixture M1p, preferably the heat exchanger 8 is upstream of the device for injecting water ES. This embodiment is exemplified in FIG. 6.

According to one embodiment, the hydrotreatment reactor 1 further comprises at least one filter F1, the filter preferably being arranged within the reactor, on the outlet line of the hydrotreated organic material M3 arranged in such a way that the hydrotreated organic material M3 passes through the filter before exiting the reactor via outlet S1. One embodiment implementing a filter in the reactor is exemplified in FIG. 1.

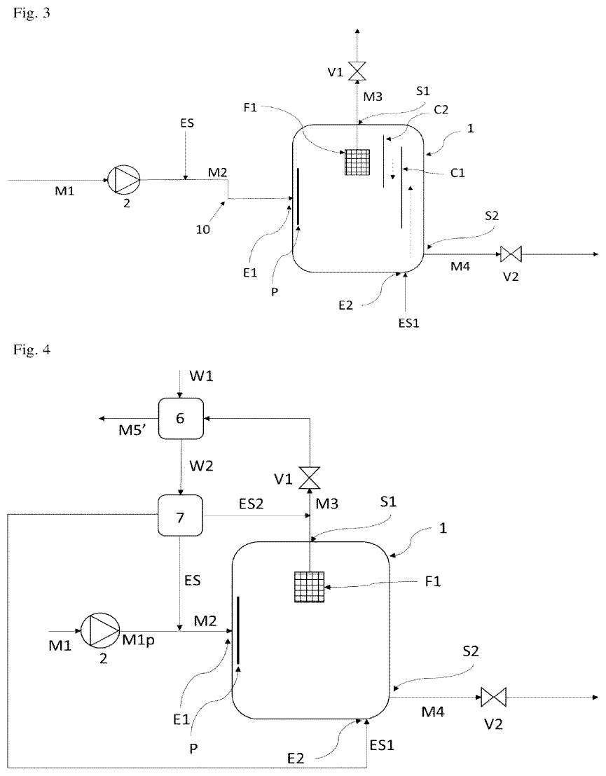

According to one embodiment, the hydrotreatment reactor 1 comprises an impact plate P and a baffle system C1, C2 to guide the upward flow created by the vertical injection of water ES1 via inlet E2 prior to its extraction via outlet S1, outlet S1 preferably being in the upper part of the reactor, allowing stream M3 to be extracted vertically from the bottom upwards. This embodiment is exemplified in FIG. 3, FIG. 5 and FIG. 6.

The baffle system can comprise two plates C1 and C2, a first plate C1 for guiding the upward flow in a vertical direction and a second plate C2, whose upper end is at an altitude higher than that of plate C1, to allow the stream arriving at the upper end of plate C1 to be directed towards the bottom of the reactor. Preferably, the lower end of plate C2 is at an altitude lower than that of the filter. This thus allows the soluble material in the stream to be drawn through the filter and the non-soluble material in the stream to sink to the bottom of the reactor.

According to one embodiment, the installation further comprises a static turbulator 10 supplied by the line of stream M2, said static turbulator being upstream of the hydrotreatment reactor 1. The mixture exiting the turbulator 10 supplies the hydrotreatment reactor 1. This embodiment is exemplified in FIG. 3.

The static turbulator can be selected from a propeller, blades or elbows or combinations thereof. Thus, for example, the feed line for the stream of mixture M2 located between the device for injecting water ES and the hydrotreatment reactor 1 may comprise one or more elbows allowing turbulence to be added, thus improving exchanges between the water and the sludge.

According to an embodiment exemplified in FIG. 1, the hydrotreatment reactor 1 implemented in the invention comprises:
an inlet E1 for the entry of stream M2 into the reactor,
an impact plate P located facing inlet E1 in order to create a mechanical impact when stream M2 is injected into the reactor,
an outlet S1 for extracting a stream M3 enriched with soluble materials,
an outlet S2 for extracting a stream M4 depleted of soluble materials, with outlet S2 being at an altitude lower than inlet E1,
an inlet E2 for injecting water directly into the reactor, with inlet E2 being at an altitude lower than inlet E1,
a filter F1 on the outlet line of stream M3 arranged so that the stream M3 passes through filter F1 before exiting the reactor via outlet S1, preferably, outlet S2 is at an altitude higher than inlet E2.

According to an embodiment exemplified in FIG. 2, the Hydrotreatment reactor 1 comprises:
an inlet E1 for the entry of stream M2 into the reactor,
an impact plate P located facing inlet E1 in order to create a mechanical impact when stream M2 is injected into the reactor,
an outlet S1 for extracting a stream M3 enriched with soluble materials,
an outlet S1′ separate from outlet S1 for extracting a stream M3′ enriched with soluble materials,
an outlet S2 for extracting a stream M4 depleted of soluble materials, with outlet S2 being at an altitude lower than inlet E1,
an inlet E2 for injecting water directly into the reactor, with inlet E2 being at an altitude lower than inlet E1,
a first filter F1 on the outlet line of stream M3 arranged so that the stream M3 passes through the first filter F1 before exiting the reactor via outlet S1,
and a second filter F1′ on the outlet line of stream M3′, arranged so that the stream M3′ passes through the second filter F1′ before exiting the reactor via outlet S1′,
preferably outlet S2 is at an altitude higher than inlet E2,
preferably outlet S1′ is at an altitude higher than inlet E1,
preferably outlets S1 and S1′ are substantially at the same altitude.

According to the embodiment implementing two filters, preferably, the installation according to the invention comprises a recombination of the lines of streams M3 and M3′. This embodiment is exemplified in FIG. 2.

FIG. 1 exemplifies one embodiment of the invention, where the installation comprises:
a feed line for mixture M1,
a pressurization pump 2 supplied by the feed line for mixture M1 and having an outlet for mixture M1p,
a heating device 11 comprising at least one device for injecting water ES into the feed line of mixture M1p downstream of pump 2,
a hydrotreatment reactor 1 comprising:
   an inlet E1 for the entry of stream M2,
   an impact plate P located facing inlet E1 in order to create a mechanical impact when stream M2 is injected into the reactor,
   an outlet S1 for extracting a stream M3 enriched with soluble materials,
   an outlet S2 for extracting a stream M4 depleted of soluble materials
   an inlet E2 for injecting water ES1, with inlet E2 being at an altitude lower than inlet E1,
   a filter F1 on the outlet line of stream M3 arranged so that the stream M3 passes through filter F1 before exiting the reactor via outlet S1,
preferably, outlet S1 is in the upper part of the reactor and allows stream M3 to be extracted vertically, from the bottom upwards, and
preferably, inlet E2 is in the lower part of the reactor and allows water to be injected vertically, from the bottom upwards,
optionally a valve V1 to control the exit of stream M3.

FIG. 3 differs from FIG. 1 in that:
a baffle system is present, and
a turbulator 10 is present upstream of the reactor and is supplied by the line of stream M2.

As exemplified in FIG. 3, the baffle system, for example consisting of two plates C1 and C2, may be present in the reactor and guides the upward flow created by the vertical injection of water via inlet E2 before the extraction thereof via outlet S1. In the case of FIG. 3, the stream around the baffle system is shown by the two dashed arrows, with an upward flow circulating on one side of the first plate C1 then a downward flow circulating on the other side of plate C1, between plates C1 and C2, this downward stream being enabled by virtue of plate C2 whose upper end is at an altitude higher than that of plate C1. As exemplified in FIG. 3, the lower end of plate C2 is preferably located at an altitude lower than that of the filter, to allow the soluble material in the stream to be drawn through the filter and the non-soluble (solid) material to sink to the bottom of the reactor.

As exemplified in FIG. 3, the turbulator 10 can be a system of elbows.

FIG. 4 exemplifies one embodiment of the invention, where the method further comprises at least one step of preheating the water to a temperature of at least 374 °C.

The installation exemplified in FIG. 4 shows a heat exchange step X1 via a heat exchanger 6. Heat exchanger 6 recovers the heat present in stream M3 exiting hydrotreatment reactor 1 to transfer it to the water in order to heat the water to be injected in the method of the invention, i.e. the water used in step d), and/or where applicable the water used in step b) and/or where applicable the water used in step f).

According to one embodiment exemplified in FIG. 4, the installation according to the invention further comprises:
a heat exchanger 6 downstream of the hydrotreatment reactor, said heat exchanger 6 recovering heat from stream M3, optionally combined with stream M3′, to obtain a cooled stream M6′ and transferring this heat to water W1 upstream of the device for injecting water ES1 and/or the device for injecting water ES1 and/or upstream of the device for injecting water ES2 to obtain a stream of heated water W2, and
a water heating device 7, downstream of the heat exchanger 6 and upstream of the device for injecting water ES, said heating device 7 being supplied with water W2 and allowing water to be obtained at a temperature of at least 374 °C, this water can then advantageously supply the device for injecting water ES and/or the device for injecting water ES1 and/or the device for injecting water ES2.

Preferably, when the installation comprises a water injection line ES2, said water ES2 is introduced into the line of stream M3 via a water feed line exiting heating device 7 (case of FIG. 4) or exiting a bypass of the water feed line ES.

According to an embodiment shown in FIG. 4, the water heating device 7 supplies water at a temperature of at least 374 °C to all water injection devices present in the installation for example the device for injecting water ES1, the device for injecting water ES and the device for injecting water ES2.

According to an embodiment not shown, the installation according to the invention comprises on the water feed line W1, a pressurization pump advantageously allowing the water to be pressurized to at least 225 bar (prior to the heating thereof).

Advantageously, the system further comprises a control unit for controlling the injection of water ES2 and outlet S2. Preferably, outlet S2 is open (by virtue of valve V2) when water is injected via feed line ES2.

According to an embodiment exemplified in FIG. 5, the installation further comprises:
a cooling device 4 supplied by at least one fraction of stream M5′ to produce steam and a cooled stream M6,
a device 3 for injecting said produced steam into the stream of mixture M1 upstream of the pressurization pump 2, said injection device 3 can be a reactor,
a cooling device 9 downstream of cooling device 4 for cooling at least one fraction of stream M6 to obtain a stream M6′, and
a digester 5 supplied by stream M6′.

According to an advantageous embodiment not shown in FIG. 5, the water heating device 7 also supplies water to the device for injecting water ES1. In particular, the installation exemplified in FIG. 5 will advantageously further comprise a water feed line connecting the heating device 7 and the injection device ES1.

As in the embodiment exemplified in FIG. 3, the installation in FIG. 5 comprises a baffle system (C1, C2).

FIG. 6 exemplifies an embodiment of the method according to the invention comprising two heat exchanges X1 and X2.

Thus, according to one embodiment exemplified in FIG. 6, the installation according to the invention comprises:
a heat exchanger 6 downstream of the hydrotreatment reactor, said heat exchanger recovering heat from stream M3, optionally combined with stream M3′, to obtain a stream M3′ and transferring this heat to water W1 upstream of a heating device 7, to obtain heated water W2,
a water heating device 7, downstream of the heat exchanger 6 supplied by heated water W2 and upstream of the device for injecting water ES1 and/or upstream of the device for injecting water ES and/or upstream of the device for injecting water ES2,
a heat exchanger 8 for recovering heat from mixture M3′ to obtain mixture M3″ and for transferring this heat to mixture M1p upstream of the device for injecting water ES,
a cooling device 4 supplied by at least one fraction of stream M3′ to produce steam and a cooled stream M6,
a device for injecting said produced steam into the stream of mixture M1 upstream of the pressurization pump 2, said injection device 3 can be a reactor,
a cooling device 9 downstream of cooling device 4 for cooling at least one fraction of stream M6 to obtain a stream M6′, and
a digester 5 supplied by stream M6′.

According to one embodiment exemplified in FIG. 6, the heating device 11, 11′ comprises a heat exchanger 8 and a device for injecting water ES. According to the embodiment exemplified in FIG. 6, the heating step b) of the method comprises two sub-steps:
a first heat exchange sub-step between stream M1p and stream M3, said stream M3 having optionally been subjected to one or more heat exchanges between the outlet of the reactor and this heat exchange with M1p,
a second sub-step of injecting water ES at a temperature of at least 374 °C and preferably at a pressure of at least 225 bar, into the line of stream M1p downstream of the first sub-step.

As in the embodiment exemplified in FIG. 3, the installation in FIG. 6 comprises a baffle system (C1, C2).

According to an advantageous embodiment not shown in FIG. 6, the water heating device 7 also supplies water to the device for injecting water ES1.

In particular, the installation exemplified in FIG. 6 will advantageously further comprise a water feed line connecting the heating device 7 and the injection device ES1.

According to an embodiment not shown in the figures, the installation according to the invention further comprises at least one post-treatment device supplied by at least one fraction of stream M3 downstream of the hydrotreatment reactor 1. When the installation further comprises at least one heat exchanger 6, then said post-treatment device is upstream of said heat exchanger 6. Preferably, said post-treatment device is selected from an additional heating step and a hydrothermal gasification step.

1. A method for hydrotreating a mixture M1 comprising at least organic material, said method comprising:
a) pressurizing mixture M1 comprising at least organic material to a pressure ranging from 20 to 350 bar, to obtain a stream of mixture M 1p;
b) heating mixture M1p to a temperature ranging from 170 °C to 430 °C to obtain a stream of mixture M2;
c) introducing the stream M2 via an inlet E1 into a hydrotreatment reactor by injection facing an impact plate to create a mechanical impact;
d) vertically injecting water ES1 at a temperature of at least 374 °C directly into the hydrotreatment reactor via inlet E2; and
e) recovering a stream M3 enriched with soluble materials and a stream M4 depleted of soluble materials, the stream M4 being recovered by an outlet S2 of the reactor,
outlet S2 and inlet E2 each being located at an altitude lower than inlet E1.

2. The hydrotreatment method according to claim 1, wherein the recovery of stream M3 enriched with soluble materials in step e) is carried out through at least one filter, said filter comprising at least one filtration layer.

3. The hydrotreatment method according to claim 1, wherein step b) comprises at least one step of injecting water ES at a temperature of at least 374 °C into the stream of mixture M1p to obtain stream M2,

4. The hydrotreatment method according to claim 2, wherein the recovery of stream M3 in step e) is controlled by determining the pressure difference between the pressure in the hydrotreatment reactor and the pressure in stream M3 at the outlet of the reactor, where applicable downstream of the filter.

5. The hydrotreatment method according to claim 1, wherein the hydrotreatment reactor is maintained at a temperature ranging from 150 °C to a temperature less than 374 °C.

6. The hydrotreatment method according to claim 2, further comprising, downstream of the filter and downstream of the reactor, a step f) of injecting water at a temperature of at least 374 °C into stream M3, against said stream.

7. The hydrotreatment method according to claim 6, wherein, when the injection of counter-current water in step f) is implemented, then outlet S2 of the reactor is opened to extract a stream M4.

8. The hydrotreatment method according to claim 1, wherein the hydrotreatment reactor further comprises a baffle system suitable for guiding an upward flow created by the vertical injection of water ES1 prior to extraction of stream M3 in step e) through an upper part of the reactor.

9. The hydrotreatment method according to claim 1, further comprising;
at least one heat exchange step X1 allowing heat to be recovered from stream M3 to at least partially heat the water to be injected in heating step b), a cooled stream M5′ then being obtained, and optionally comprising at least one additional water heating step, downstream of the heat exchange X1 allowing the water to be heated to the temperature of at least 374 °C prior to its injection in step d), and/or where applicable prior to its injection in step b) and/or where applicable prior to its injection in step f); and
optionally at least one heat exchange step X2 to recover heat from stream M5′ to heat mixture M1p upstream of the injection of water in step b), a stream M5″ then being obtained.

10. The hydrotreatment method according to claim 9, further comprising:
at least one step of cooling at least one fraction of stream M5′ or where applicable stream M5″ to obtain steam and stream M6 comprising hydrotreated organic material;
a step of injecting at least part of said steam to preheat mixture M1 upstream of pressurization step a); and
optionally a step of cooling at least one fraction of stream M6 to obtain a cooled stream M6′ and optionally a step of digesting stream M6′.

11. The hydrotreatment method according to claim 1, wherein the impact plate comprises an erosion-resistant thickening.

12. An installation suitable for implementing the hydrotreatment method according to claim 1, said installation comprising:
a feed line for mixture M1;
a pressurization pump supplied by the feed line for mixture M1 and comprising an outlet line for mixture M1p;
a heating device supplied by at least one fraction of mixture M1p downstream of pump and having an outlet for the stream of mixture M2;
downstream of the heating device, a hydrotreatment reactor comprising an inlet E1 suitable for injecting stream M2, an inlet E2 suitable for injecting water ES1, an outlet S1 suitable for extracting stream M3 and an outlet S2 suitable for extracting stream M4, said reactor further comprising at least one impact plate located facing inlet E1 to create a mechanical impact when stream M2 is injected into the reactor; and
a device suitable for injecting water ES1 directly into the reactor, allowing vertical injection from a bottom upwards via inlet E2 of the reactor
outlet S2 and inlet E2 each being located at an altitude lower than inlet E1.

13. The installation according to claim 12, wherein the hydrotreatment reactor further comprises:
at least a first filter F1, said first filter being arranged so that the stream M3 enriched with soluble materials passes through the filter before exiting the reactor via outlet S1; and
optionally at least a second filter F1′, said second filter F1′ being arranged in such a way that stream M3′ enriched with soluble materials passes through said second filter F1′ before exiting the reactor via an outlet S1′.

14. The installation according to claim 12, wherein the hydrotreatment reactor further comprises a baffle system suitable for guiding an upward flow created by the vertical injection of water via inlet E2 prior to its extraction via outlet S1.

15. The installation according to claim 12, wherein the heating device comprises at least one device suitable for injecting water ES into the line of mixture M1p.

16. The installation according to claim 15, further comprising:
a heat exchanger downstream of the hydrotreatment reactor, said heat exchanger recovering heat from the line of stream M3, optionally combined with the line of stream M3′, to obtain stream M5′ and transferring this heat to the water upstream of the device suitable for injecting water ES1 and/or upstream of the device suitable for injecting water ES; and
a water heating device, downstream of the heat exchanger and upstream of the device suitable for injecting water ES and upstream of the device suitable for injecting water ES1, said heating device advantageously comprising at least two outlet lines, one line connected to the device suitable for injecting water ES1 and one line connected to the device suitable for injecting water ES.

17. The installation according to claim 16, further comprising:
optionally a heat exchanger suitable for recovering heat from mixture M5′ to obtain mixture M5″ and suitable for transferring this heat to mixture M1p upstream of the device suitable for injecting water ES;
a cooling device supplied by at least one fraction of stream M5′ or where applicable M5″ to produce steam and a cooled stream M6;
a device suitable for injecting said produced steam into the stream of mixture M1 upstream of the pressurization pump;
optionally a cooling device downstream of the cooling device supplied by at least one fraction of stream M6 suitable for cooling at least one fraction of stream M6 to obtain stream M6′; and
optionally a digester supplied by stream M6′.
